(19) United States
(12) Patent Application Publication
(10) Pub. No.: US 2025/0222698 A1
(43) Pub. Date: Jul. 10, 2025

(54) PRINTER

(71) Applicant: Roland DG Corporation, Hamamatsu-shi (JP)

(72) Inventors: Kazuya MORIZONO, Hamamatsu-shi (JP); Takayoshi OGURI, Hamamatsu-shi (JP)

(21) Appl. No.: 19/010,457

(22) Filed: Jan. 6, 2025

(30) Foreign Application Priority Data
Jan. 9, 2024 (JP) 2024-001084

(51) Int. Cl. B41J 2/175; B41J 2/045; B41J 2/165; B41J 2/17

(52) U.S. Cl. CPC B41J 2/17596; B41J 2/04573; B41J 2/16505; B41J 2/1707; B41J 2/04586; B41J 2002/16594

(57) ABSTRACT

A printer includes an ink container to accommodate ink, an ink head to eject the ink, an ink flow path including a first flow path and a second flow path, the ink flow path connecting the ink container and the ink head to each other, a liquid feeding pump provided in the first flow path to feed the ink in a direction from the ink container toward the ink head, and a depressurizing pump provided in the second flow path to feed the ink in a direction from the ink head toward the ink container.

### CROSS REFERENCE TO RELATED APPLICATION

This application claims the benefit of priority to Japanese Patent Application No. 2024-001084 filed on Jan. 9, 2024. The entire contents of this application are hereby incorporated by reference herein.

### BACKGROUND OF THE INVENTION

### 1. Field of the Invention

The present invention relates to printers.

### 2. Description of the Related Art

A printer is conventionally known that includes an ink head having nozzles formed therein through which ink is ejected, also includes an ink flow path through which the ink is supplied to the ink head, and pressurizes the ink in the ink flow path to cause the ink to leak out through the nozzles and thus to clean the nozzles. For example, Japanese Patent Application Publication No. 2020-131713 discloses an inkjet recording device including a recording head and an ink supply mechanism supplying ink to the recording head. In the inkjet recording device disclosed in Japanese Patent Application Publication No. 2020-131713, the ink supply mechanism includes a tank storing the ink and a pump providing a positive pressure or a negative pressure to the ink. The pump changes the rotation direction of a driving motor to change the direction of pressurization. The inkjet recording device disclosed in Japanese Patent Application Publication No. 2020-131713 drives the pump to rotate forward to provide a positive pressure to the ink and thus causes the ink to leak out from an ink ejection surface of the recording head. The inkjet recording device disclosed in Japanese Patent Application Publication No. 2020-131713 also drives the pump to rotate reversely to provide a negative pressure to the ink and thus stops the leak of the ink from the ink ejection surface.

With the configuration by which the pump of the ink supply mechanism is rotated reversely to depressurize the ink, like that in the inkjet recording device disclosed in Japanese Patent Application Publication No. 2020-131713, a time lag occurs at the time when the rotation direction of the pump is switched from the forward direction to the reverse direction. When the ink is pressurized and discharged, the ink is accumulated on surfaces of the nozzles, and the ink accumulated on the nozzles close to each other is assembled. When the pump is stopped after the pressurization, the ink, which is assembled and color-mixed, is pulled into a nozzle having a smaller inner pressure by a difference in the pressure between the nozzles while the pump is stopped by the time lag. This causes the ink to be color-mixed for a long time period or at an unexpected timing during the printing.

### SUMMARY OF THE INVENTION

Example embodiments of the present invention provide printers each reducing or preventing a time lag at a time when pressurization and depressurization of an ink flow path are switched.

A printer according to an example embodiment of the present invention includes an ink container to accommodate ink, an ink head to eject the ink, an ink flow path including a first flow path and a second flow path, the ink flow path connecting the ink container and the ink head to each other, a liquid feeding pump provided in the first flow path to feed the ink in a direction from the ink container toward the ink head, and a depressurizing pump provided in the second flow path to feed the ink in a direction from the ink head toward the ink container.

According to the above-described printer, the liquid feeding pump may be driven to pressurize the inside of the ink flow path, and the depressurizing pump may be driven to depressurize the inside of the ink flow path. The liquid feeding pump and the depressurizing pump are different pumps from each other, and therefore, the time lag between the pressurization and the depressurization is reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a printer according to example embodiment 1 of the present invention.

FIG. 2 is a front view of the printer in a state where a front cover is opened.

FIG. 3 is a schematic view showing a configuration of an ink supply system and a capping device.

FIG. 4 is a schematic cross-sectional view of a liquid feeding pump.

FIG. 5 is a block diagram of the printer.

FIG. 6 is a flowchart of pressurization cleaning.

FIG. 7 is a flowchart of in-and-out stirring.

FIG. 8 is a schematic view showing a configuration of an ink supply system according to example embodiment 2 of the present invention.

FIG. 9 is a block diagram of a printer according to example embodiment 2 of the present invention.

FIG. 10 is a flowchart showing an example of pressure adjustment circulation.

FIG. 11 is a schematic view showing a configuration of an ink supply system according to example embodiment 3 of the present invention.

FIG. 12 is a block diagram of a printer according to example embodiment 3 of the present invention.

FIG. 13 is a flowchart showing an example of pressure adjustment circulation performed by the printer according to example embodiment 3 of the present invention.

### DETAILED DESCRIPTION OF THE EXAMPLE EMBODIMENTS

Hereinafter, example embodiments of the present invention will be described with reference to the drawings. The example embodiments described herein are not intended to specifically limit the present invention. Components and portions having the same functions will bear the same reference signs, and overlapping descriptions will be omitted or simplified as appropriate.

### Example Embodiment 1

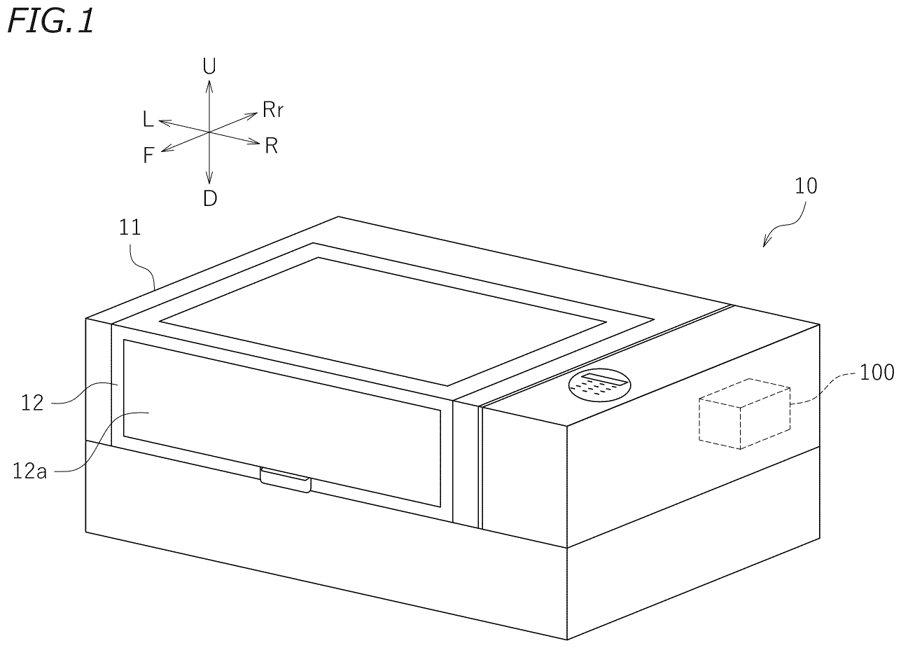

FIG. 1 is a perspective view of an inkjet printer 10 (hereinafter, referred to simply as the “printer 10”) according to example embodiment 1. In the following description, as seen from a position in front of the printer 10, a direction getting farther from the printer 10 will be referred to as a “forward direction”, and a direction getting closer to the printer 10 will be referred to as a “rearward direction”, unless otherwise specified. The term “left”, “right”, “up” and “down” respectively indicate left, right, up and down as seen from a position in front of the printer 10. In the drawings, letters F, Rr, L, R, U and D respectively indicate front, rear, left, right, up and down. Note that the above-mentioned directions are provided merely for the sake of convenience, and do not limit the manner of installation of the printer 10 in any way, and do not limit the present invention in any way.

In this example embodiment, the printer 10 is of an inkjet system. In this example embodiment, the “inkjet system” refers to an inkjet system using any of various conventionally known techniques including various continuous methods including a binary deflection method, a continuous deflection method and the like, and various on-demand methods including a thermal method, a piezoelectric element method and the like.

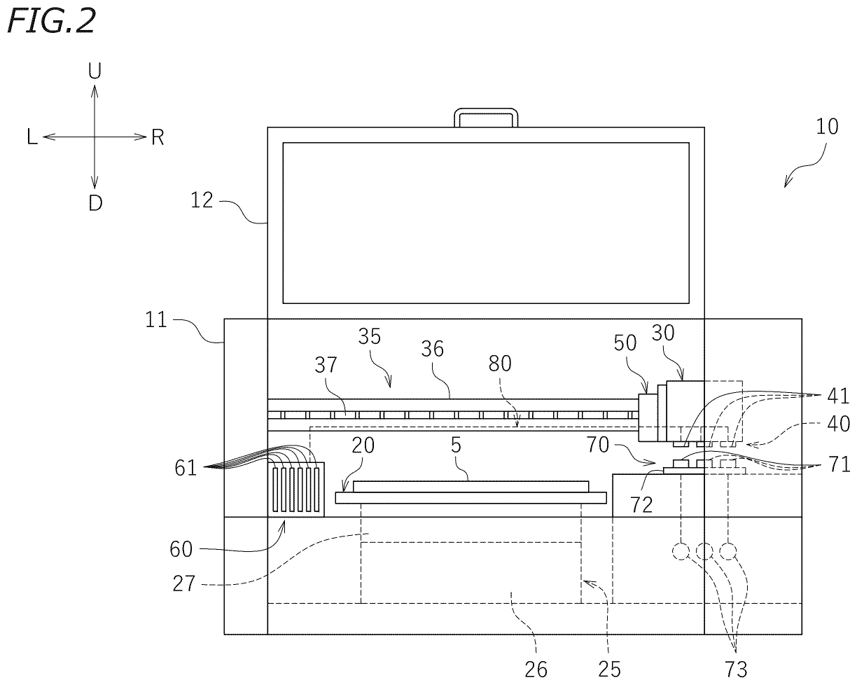

As shown in FIG. 1, the printer 10 is box-shaped. In this example embodiment, the printer 10 includes a case 11 and a front cover 12. FIG. 2 is a front view showing the printer 10 in a state where the front cover 12 is opened. As shown in FIG. 2, an opening is formed in a front portion of the case 11. The front cover 12 is provided to freely open or close the opening. In this example embodiment, the front cover 12 is supported by the case 11 so as to be rotatable about a rear end thereof as a rotation axis. The front cover 12 includes a window 12a formed therein. The window 12a is formed of, for example, a transparent acrylic plate. A user may visually recognize an inner space of the case 11 through the window 12a.

As shown in FIG. 2, the inner space of the printer 10 accommodates a flat bed 20, a bed moving device 25, a carriage 30, a carriage moving device 35, a recording head 40, a light radiation device 50, an ink cartridge housing 60, a capping device 70, and a controller 100 (see FIG. 1). The printer 10 includes ink supply systems 80 to supply ink in a plurality of ink cartridges 61 accommodated in the ink cartridge housing 60 to the recording head 40.

The flat bed 20 is a support table supporting a recording medium 5. The printer 10 according to this example embodiment is a so-called flat bed-type printer. The flat bed 20 is a flat plate-shaped structure. There is no specific limitation on the shape of the recording medium 5. The recording medium 5 may have any shape, for example, a flat plate shape, any of various three-dimensional shapes, or the like. There is no specific limitation on the material of the recording medium 5. The recording medium 5 may be formed of, for example, wood, metal, glass, paper, cloth or the like. In the inner space of the case 11, the flat bed 20 is located at substantially the center in a left-right direction.

The bed moving device 25 is located below the flat bed 20. The bed moving device 25 moves the flat bed 20 in a front-rear direction and an up-down direction. The flat bed 20 is supported by the bed moving device 25 from below. The bed moving device 25 includes a front-rear direction moving device 26 and an up-down direction moving device 27. The up-down direction moving device 27 supports the flat bed 20 and moves the flat bed 20 in the up-down direction. The up-down direction moving device 27 is supported by the front-rear direction moving device 26 from below. The front-rear direction moving device 26 supports the up-down direction moving device 27 and moves the up-down direction moving device 27 in the front-rear direction. Note that there is no specific limitation on the configuration of the bed moving device 25. For example, the front-rear direction moving device 26 and the up-down direction moving device 27 may be positioned oppositely to the above in the up-down direction.

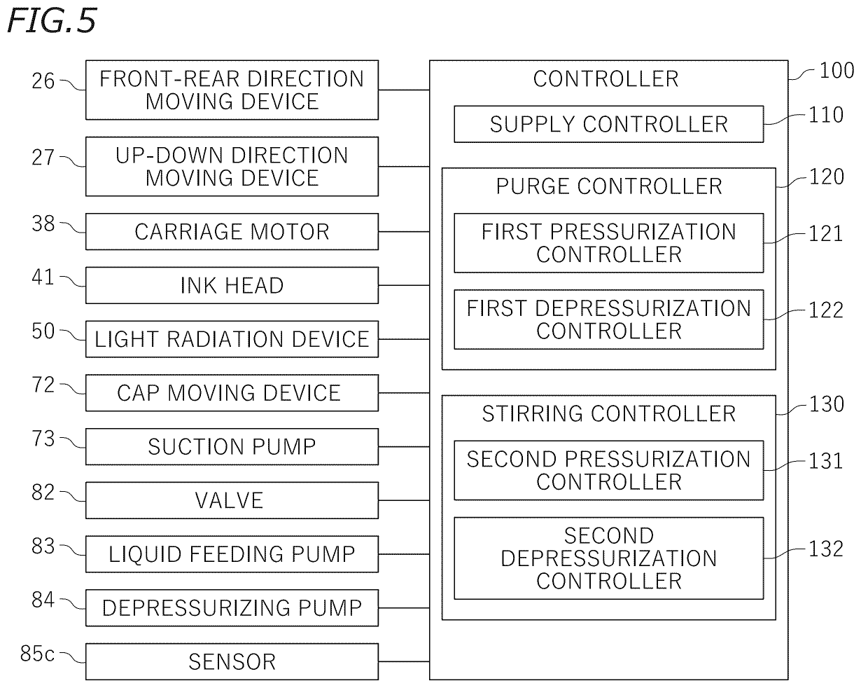

The carriage 30 has the recording head 40 and the light radiation device 50 mounted thereon. The carriage 30 is provided above the flat bed 20. The carriage 30 is moved in the left-right direction by the carriage moving device 35. The carriage moving device 35 includes a guide rail 36, a belt 37, left and right pulleys (not shown), and a carriage motor 38 (see FIG. 5).

As shown in FIG. 2, the guide rail 36 extends in the left-right direction. The carriage 30 is in slidable engagement with the guide rail 36. The belt 37, which is endless, is secured to the carriage 30. The belt 37 is wound along the pulleys (not shown) provided to the right of, and to the left of, the guide rail 36. The carriage motor 38 is attached to one of the pulleys. When the carriage motor 38 is driven, the pulleys are rotated to run the belt 37. As a result, the carriage 30 is moved in the left-right direction along the guide rail 36.

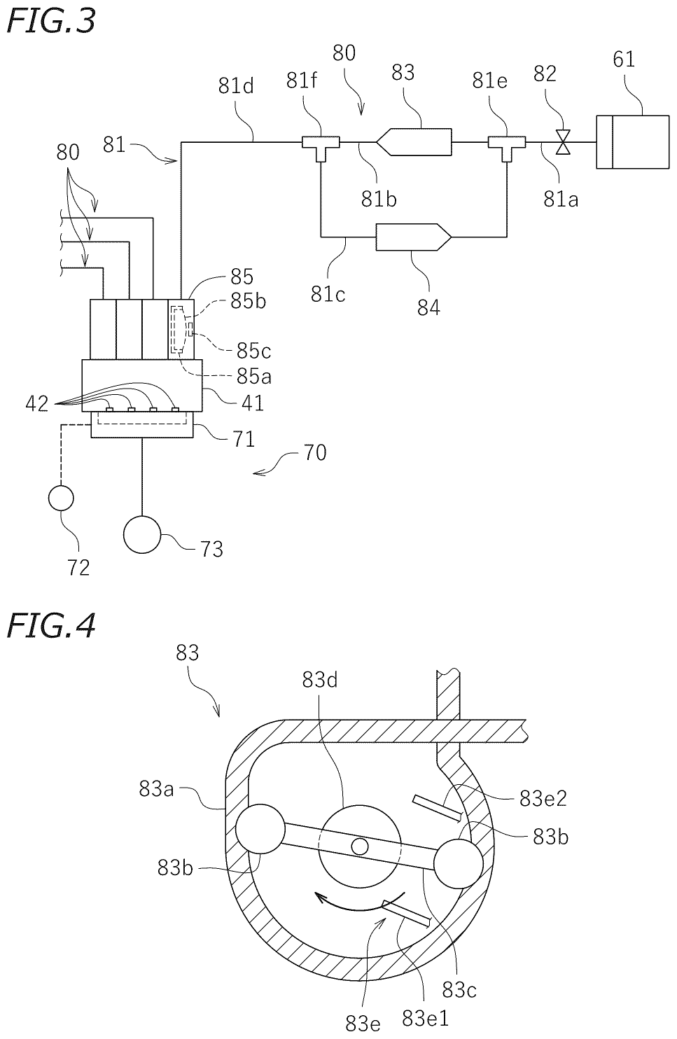

As shown in FIG. 2, the recording head 40 is provided on a bottom surface of the carriage 30. The recording head 40 is provided above the flat bed 20. The recording head 40 includes a plurality of ink heads 41. The plurality of ink heads 41 each eject ink. The plurality of ink heads 41 are arranged in a line in the left-right direction. Although not shown, the plurality of ink heads 41 each extend in the front-rear direction. The plurality of ink heads 41 each include a plurality of nozzles 42 (see FIG. 3), through which ink is ejected. The plurality of ink heads 41 each include a bottom surface acting as a nozzle surface in which the plurality of nozzles 42 are located.

In this example embodiment, the ink to be ejected through the nozzles 42 of the recording head 40 is photocurable ink. In this example embodiment, the photocurable ink is ultraviolet-curable ink, which is cured when being irradiated with ultraviolet rays. Note that there is no specific limitation on the components, characteristics or the like of the ink. The ink may be, for example, thermosetting ink.

The light radiation device 50 is provided to the left of the recording head 40. The light radiation device 50 radiates light that cures the photocurable ink toward the flat bed 20. The light radiation device 50 includes a light source (not shown) including, for example, a plurality of ultraviolet-radiating LEDs. The light radiation device 50 includes a radiation opening (not shown) formed therein. The radiation opening is opened downward and transmits light generated by the light source.

The ink cartridge housing 60 is capable of accommodating the plurality of ink cartridges 61. Each of the ink cartridges 61 is an example of an ink container that accommodates ink. The ink cartridges 61 each accommodate a pouch in which the ink is stored. The ink cartridges 61 are attachable to, and detachable from, the ink cartridge housing 60. Note that the ink containers are not limited to the ink cartridges 61, and may be pouches, for example. The ink containers may be tanks in which ink supplemented from the bottles or the like is stored, for example.

The capping device 70 includes a plurality of caps 71, a cap moving device 72, and a plurality of suction pumps 73. FIG. 3 is a schematic view showing a configuration of the ink supply system 80 and the capping device 70. As shown in FIG. 3, one cap 71 and one suction pump 73 are provided for one ink head 41. In this example embodiment, one cap moving device 72 is provided. The cap 71 is attachable to the ink head 41. The cap 71 has a container shape having a top surface thereof opened. The cap 71 is formed of rubber or the like. For attaching the cap 71 to the ink head 41, a top edge of the cap 71 is closely adhered to the nozzle surface of the ink head 41. The cap 71 is attached to the ink head 41 in order to protect the ink head 41 and prevent the ink head 41 from drying. As described below, the ink in the ink head 41 is discharged into the cap 71 as appropriate.

The plurality of caps 71 are supported by the cap moving device 72. The cap moving device 72 attach the plurality of caps 71 to, or detach the plurality of caps 71 from, the nozzle surfaces of the ink heads 41. The cap moving device 72 supports the plurality of caps 71 from below and moves the plurality of caps 71 in the up-down direction. As a result, the caps 71 are attached to, or detached from, the ink heads 41. The cap moving device 72 may include, for example, a driving motor (not shown). The cap moving device 72 may slide the caps 71 in an oblique direction, instead of moving the caps 71 in the up-down direction, to attach the caps 71 to the ink heads 41.

As shown in FIG. 2, the suction pumps 73 are connected with the caps 71. The suction pumps 73 suction the ink discharged into the caps 71. The suction pumps 73 are, for example, depressurizing pumps.

The ink supply systems 80 supply the ink accommodated in the ink cartridges 61 to the recording head 40. As shown in FIG. 3, one ink supply system 80 is provided for one ink cartridge 61. In this example embodiment, a plurality of the ink supply systems 80 are connected with one ink head 41. Note that one ink supply system 80 may be connected to one ink head 41.

As shown in FIG. 3, each of the ink supply systems 80 includes an ink flow path 81, a valve 82, a liquid feeding pump 83, a depressurizing pump 84, and a damper 85 (note that FIG. 3 shows the configuration of one ink supply system 80). The ink flow path 81 connects the ink cartridge 61 and the ink head 41 to each other, and communicates the ink cartridge 61 and the plurality of nozzles 42 to each other. The valve 82 is provided in the ink flow path 81, and opens or closes the ink flow path 81. The liquid feeding pump 83 is provided in the ink flow path 81, and feeds the ink in a direction from the ink cartridge 61 toward the ink head 41. The depressurizing pump 84 is provided in the ink flow path 81, and feeds the ink in a direction from the ink head 41 toward the ink cartridge 61. The depressurizing pump 84 returns the ink toward the ink cartridge 61. The damper 85 is an example of intermediate container that stores the ink to alleviate a change in the pressure of the ink.

As shown in FIG. 3, the ink flow path 81 includes an upstream-side common flow path 81a, a first flow path 81b and a second flow path 81c both branched from the upstream-side common flow path 81a, and a downstream-side common flow path 81d, into which the first flow path 81b and the second flow path 81c are merged. The ink flow path 81 includes a first branching portion 81e branching the upstream-side common flow path 81a into the first flow path 81b and the second flow path 81c, and a second branching portion 81f merging the first flow path 81b and the second flow path 81c into the downstream-side common flow path 81d. In this example embodiment, the upstream-side common flow path 81a, the first flow path 81b, the second flow path 81c and the downstream-side common flow path 81d are formed of a flexible tube. Note that these flow paths are not limited to being formed of a flexible tube, and may be formed of, for example, a pipe of a fixed shape.

As shown in FIG. 3, an upstream end of the upstream-side common flow path 81a is connected with the ink cartridge 61. A downstream end of the upstream-side common flow path 81a is connected with the first branching portion 81e. The upstream-side common flow path 81a is provided with the valve 82. The first branching portion 81e is connected with an upstream end of the first flow path 81b and an upstream end of the second flow path 81c. In this example embodiment, the first branching portion 81e is formed of a tube joint branched into three directions. The first flow path 81b is provided with the liquid feeding pump 83. The second flow path 81c is provided with the depressurizing pump 84.

The second branching portion 81f is connected with a downstream end of the first flow path 81b and a downstream end of the second flow path 81c. The second branching portion 81f is also connected with an upstream end of the downstream-side common flow path 81d. The second branching portion 81f is also formed of a tube joint branched into three directions. A downstream end of the downstream-side common flow path 81d is connected with the damper 85. The downstream-side common flow path 81d is in communication with the ink head 41 via the damper 85.

The liquid feeding pump 83 is capable of opening and closing an inner flow path thereof and is capable of being driven and stopped. In this example embodiment, the liquid feeding pump 83 is a tube pump. FIG. 4 is a schematic cross-sectional view of the liquid feeding pump 83. As shown in FIG. 4, the liquid feeding pump 83 includes an inner flow path 83a, a pair of rollers 83b, an arm 83c, a motor 83d, and a roller retraction mechanism 83e.

The inner flow path 83a may include a flexible tube and ink may pass therethrough. Both of two ends of the inner flow path 83a are connected with the first flow path 81b. The liquid feeding pump 83 causes the pair of rollers 83b to squeeze the inner flow path 83a to feed the ink. As shown in FIG. 4, the pair of rollers 83b are respectively located at both of two ends of the arm 83c. The motor 83d rotates the arm 83c such that the pair of rollers 83b move along an arched portion of the inner flow path 83a. As a result, the pair of rollers 83b squeeze the inner flow path 83a.

The roller retraction mechanism 83e is capable of separating the pair of rollers 83b from the inner flow path 83a. When the motor 83d is rotated reversely, the roller retraction mechanism 83e separates the pair of rollers 83b from the inner flow path 83a. As shown in FIG. 4, in this example embodiment, the roller retraction mechanism 83e includes a pair of rubber plates 83e1 and 83e2. When the motor 83d is rotated reversely, the pair of rollers 83b are moved by the rubber plates 83e1 and 83e2 to positions separated from the inner flow path 83a. As a result, the liquid feeding pump 83 is opened. When the motor 83d is rotated forward in the state where the liquid feeding pump 83 is opened, the pair of rollers 83b are moved by the rubber plates 83e1 and 83e2 to such positions as to squash the inner flow path 83a. As a result, the liquid feeding pump 83 is closed. When the motor 83d is rotated forward in the state where the liquid feeding pump 83 is closed, the ink is fed. In this example embodiment, the liquid feeding pump 83 is incapable of feeding the ink in the opposite direction.

The liquid feeding pump 83 is capable of opening and closing the inner flow path 83a and is capable of feeding the ink. The expression that “the liquid feeding pump 83 is stopped” indicates that the inner flow path 83a is closed and the motor 83d is not driven, and in this example embodiment, indicates the same as the inner flow path 83a being closed.

In this example embodiment, the depressurizing pump 84 has substantially the same configuration as that of the liquid feeding pump 83. The depressurizing pump 84 is also capable of opening and closing an inner flow path thereof and is capable of being driven and stopped. Note that the liquid feeding pump 83 and the depressurizing pump 84 are not limited to being tube pumps. The liquid feeding pump 83 and the depressurizing pump 84 may have different configurations from each other.

The damper 85 is in communication with the ink head 41. The damper 85 is capable of storing the ink. As shown in FIG. 3, the damper 85 includes a main body 85a, a damper membrane 85b, and a sensor 85c. When the amount of the ink in a space partitioned by the main body 85a and the damper membrane 85b is increased and as a result, the damper membrane 85b is expanded outward by an amount equal to, or more than, a predetermined amount, the sensor 85c senses this state. When the sensor 85c senses that the amount of the expansion of the damper membrane 85b exceeds the predetermined amount, the ink supply system 80 stops the liquid feeding pump 83. When the sensor 85c senses that the amount of the expansion of the damper membrane 85b becomes less than the predetermined amount as a result the ink being consumed, the ink supply system 80 drives the liquid feeding pump 83. The ink supply system 80 drives and stops the liquid feeding pump 83 in repetition to supply the ink to the ink head 41. In a normal state, the ink flow path 81 is maintained to have a negative pressure such that a meniscus of the ink is formed on the nozzles 42.

FIG. 5 is a block diagram of the printer 10. As shown in FIG. 5, the controller 100 is electrically connected with, and is configured or programmed to control operations of, the front-rear direction moving device 26 and the up-down direction moving device 27 of the bed moving device 25, the carriage motor 38 of the carriage moving device 35, the plurality of ink heads 41 (only one is shown in FIG. 5), the light radiation device 50, the cap moving device 72 and the plurality of suction pumps 73 (only one is shown in FIG. 5) of the capping device 70, and the valves 82 (only one is shown in FIG. 5), the liquid feeding pumps 83 (only one is shown in FIG. 5) and the depressurizing pumps 84 (only one is shown in FIG. 5) of the ink supply systems 80. The controller 100 is electrically connected with the sensors 85c (only one is shown in FIG. 5) of the dampers s signals transmitted by the sensors 85c. The controller 100 may be, for example, a microcomputer, and may include a central processing unit (hereinafter, referred to as the “CPU”), a ROM storing a program to be executed by the CPU or the like, a RAM and the like. Each of such components of the controller 100 may include software or hardware. Each of such components of the controller 100 may be a processor or a circuit. There is no specific limitation on the configuration of the controller 100.

As shown in FIG. 5, the controller 100 is configured or programmed to include a supply controller 110, a purge controller 120 and a stirring controller 130 as controllers configured or programmed to control the ink supply systems 80. The controller 100 may be configured or programmed to include another controller such as a controller configured or programmed to control a printing operation or the like, but such a controller will not be described herein. Hereinafter, descriptions regarding the control of the ink supply systems 80 by the controller 100 will be made on one ink supply system 80.

The supply controller 110 is configured or programmed to control an operation of supplying the ink to the ink head 41. When the ink is consumed by printing or the like, the supply controller 110 is configured or programmed to supply the ink to the ink head 41 via the damper 85. In more detail, when the sensor 85c senses that the amount of the expansion of the damper membrane 85b becomes less than the predetermined amount as a result of the ink being consumed, the supply controller 110 is configured or programmed to drive the liquid feeding pump 83. When the sensor 85c senses that the amount of the expansion of the damper membrane 85b becomes equal to, or more than, the predetermined amount as a result of the ink being supplied to the damper 85, the supply controller 110 is configured or programmed to stop the liquid feeding pump 83.

As shown in FIG. 5, the purge controller 120 is configured or programmed to include a first pressurization controller 121 and a first depressurization controller 122. The first pressurization controller 121 is configured or programmed to close the depressurizing pump 84 and to drive the liquid feeding pump 83 to pressurize the inside of the ink flow path 81 to a pressure at which the ink leaks out from the ink head 41. Such pressurization causes old ink to be pushed out from the nozzles 42, and thus the ink head 41 is cleaned. The first depressurization controller 122 is configured or programmed to close the liquid feeding pump 83 and to drive the depressurizing pump 84 to depressurize the inside of the ink flow path 81. As a result, the pressure inside the ink flow path 81 is returned to a negative pressure. Hereinafter, the cleaning of the ink head 41 performed under the control of the purge controller 120 will be referred to also as “pressurization cleaning”.

The stirring controller 130 is configured or programmed to include a second pressurization controller 131 and a second depressurization controller 132. The second pressurization controller 131 is configured or programmed to close the depressurizing pump 84 and to drive the liquid feeding pump 83 to pressurize the inside of the ink flow path 81 to a pressure at which the ink does not leak out from the ink head 41. The second depressurization controller 132 is configured or programmed to close the liquid feeding pump 83 and to drive the depressurizing pump 84 to depressurize the inside of the ink flow path 81 to a pressure at which the ink is not pulled into the ink head 41. The stirring controller 130 is configured or programmed to repeat such pressurization and depressurization to stir the ink in the ink flow path 81 and the damper 85. Hereinafter, the stirring of the ink performed under the control of the stirring controller 130 will be referred to as “in-and-out stirring”.

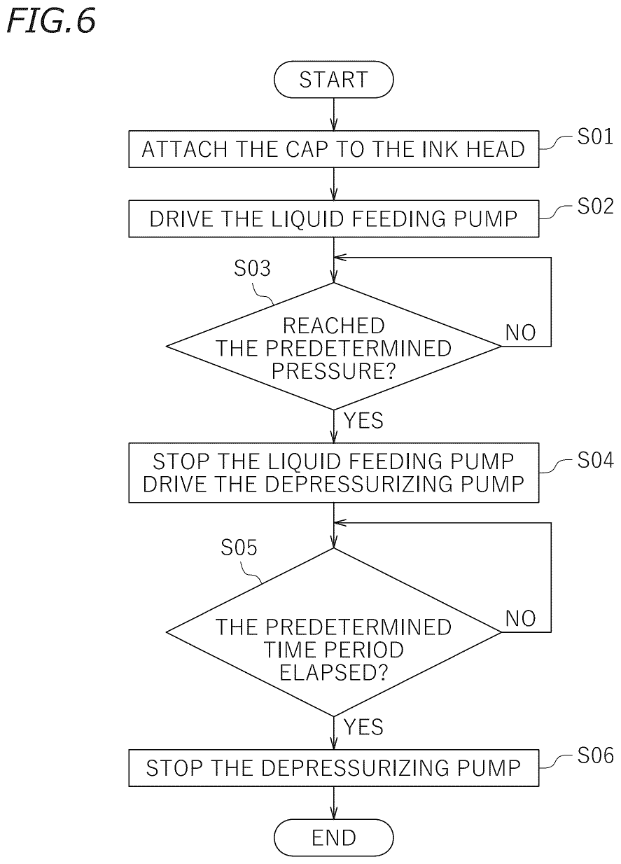

Hereinafter, a process of the pressurization cleaning will be described. FIG. 6 is a flowchart of the pressurization cleaning. During the pressurization cleaning, the valve 82 is opened. As shown in FIG. 6, in step S01 of the pressurization cleaning, the cap 71 is attached to the ink head 41. In step S02 of the pressurization cleaning, the liquid feeding pump 83 is driven. As a result, the pressure of the ink inside the ink flow path 81 is increased, and the ink leaks out from the nozzles 42. The leaked ink is accommodated in the cap 71.

In step S03, it is determined whether or not the pressure of the ink has reached a predefined pressure. In the case where the pressure of the ink has not reached the predefined pressure (in the case where the determination result in step S03 is NO), the state of step S02 is maintained. When the pressure of the ink reaches the predefined pressure (when the determination result in step S03 becomes YES), the liquid feeding pump 83 is stopped in step S04 after an elapse of a predefined time period. In this example embodiment, the timing to finish the pressurization is managed by the pressure of the ink and the time. In step S04, the depressurizing pump 84 is driven at the same time as the stop of the liquid feeding pump 83. As a result, the pressure inside the pressurized ink flow path 81 is returned to a negative pressure. The depressurizing pump 84 may be driven slightly before the liquid feeding pump 83 is stopped. In this case, the time lag does not occur when the pressurization is switched to the depressurization.

In step S05, it is determined whether or not a predetermined time period has elapsed after the depressurizing pump 84 is driven. In the case where the predetermined time period has not elapsed (in the case where the determination result in step S05 is NO), the state of step S04 is maintained. When the predetermined time period elapses (when the determination result in step S05 becomes YES), the depressurizing pump 84 is stopped in step S06. In this example embodiment, the timing to finish the depressurization is managed by the time. Note that the timing to finish the depressurization may be managed by, for example, the pressure inside the damper 85. The depressurizing pump 84 may be stopped when, for example, the sensor 85c of the damper 85 senses that the amount of the expansion of the dumper membrane 85b becomes less than the predetermined amount. Alternatively, the depressurizing pump 84 may be stopped when a predetermined time period elapses after the sensor 85c senses that the amount of the expansion of the dumper membrane 85b becomes less than the predetermined amount.

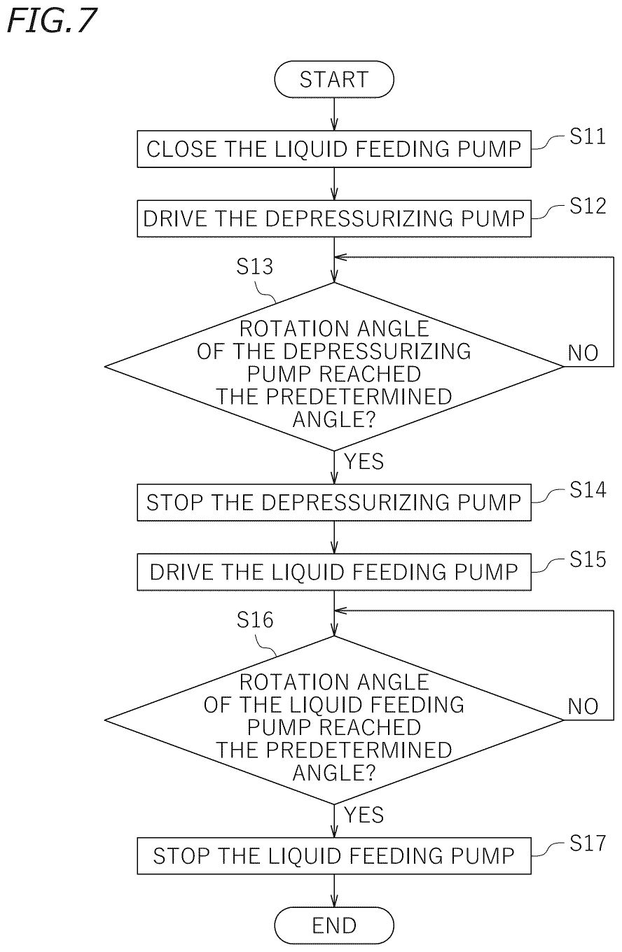

Now, a process of the in-and-out stirring will be described. FIG. 7 is a flowchart of the in-and-out stirring. During the in-and-out stirring, the valve 82 is opened. As shown in FIG. 7, in step S11 of the in-and-out stirring, the liquid feeding pump 83 is closed. In step S12, the depressurizing pump 84 is driven to depressurize the inside the ink flow path 81 to a pressure at which the ink is not pulled into the ink head 41. In this example embodiment, the pressure inside the ink flow path 81 is managed by the amount of the ink returned to the ink cartridge 61 by the depressurizing pump 84. The amount of the ink returned to the ink cartridge 61 by the depressurizing pump 84 is managed by the rotation angle of the depressurizing pump 84. In step S12, the depressurizing pump 84 is driven to rotate by, for example, a predetermined rotation angle at which it is confirmed in advance that the ink is not pulled into the ink head 41.

In step S13, it is determined whether or not the rotation angle of the depressurizing pump 84 has reached the predetermined angle. In the case where the rotation angle has not reached the predetermined angle (in the case where the determination result in step S13 is NO), the state of step S12 is maintained. When the rotation angle of the depressurizing pump 84 reaches the predetermined angle (when the determination result in step S13 becomes YES), the depressurizing pump 84 is stopped (closed) in step S14. Note that in the process of the depressurization, for example, the pressure of the ink may be sensed, and the depressurizing pump 84 may be driven until the pressure of the ink becomes a predetermined pressure at which it is confirmed in advance that the ink is not pulled into the ink head 41.

In step S15, the liquid feeding pump 83 is driven to pressurize the inside of the ink flow path 81 to a pressure at which the ink does not leak out from the ink head 41. For the case where the ink leaks out from the ink head 41, the ink head 41 may have the cap 71 attached thereto. In this case also, the pressure inside the ink flow path 81 is managed by the amount of the ink fed to the ink head 41 by the liquid feeding pump 83. The amount of the ink fed to the ink head 41 by the liquid feeding pump 83 is managed by the rotation angle of the liquid feeding pump 83. In step S16, it is determined whether or not the rotation angle of the liquid feeding pump 83 has reached a predetermined angle. In the case where the rotation angle has not reached the predetermined angle (in the case where the determination result in step S16 is NO), the state of step S15 is maintained. When the rotation angle of the liquid feeding pump 83 reaches the predetermined angle (when the determination result in step S16 becomes YES), the liquid feeding pump 83 is stopped (closed) in step S17. Note that in the process of the pressurization, for example, the pressure of the ink may be sensed, and the liquid feeding pump 83 may be driven until the pressure of the ink becomes a predetermined pressure at which it is confirmed in advance that the ink does not leak out from the ink head 41.

After this, a depressurization process the same as that of steps S11 through S14 and a pressurization process the same as that of steps S15 through S17 are repeated by a predefined number of times, although not shown. Note that the depressurization process and the pressurization process may each be performed once. The pressurization process may be performed before the depressurization process.

The depressurizing pump 84 and the liquid feeding pump 83 are driven alternately, so that the discharge of the ink from the damper 85 and the supply of the ink to the damper 85 are performed alternately. As a result, the ink in the ink flow path 81 and the damper 85 is stirred. Such stirring, when performed at an appropriate time, reduces or prevents sedimentation of components of the ink. In the case of, for example, solvent ink, sedimentation of the pigment of the ink, particularly, the pigment of white ink, for example, is reduced or prevented.

Hereinafter, the functions and effects provided by the printer 10 in example embodiment 1 will be described.

The printer 10 according to this example embodiment includes the ink cartridge 61 accommodating ink, the ink head 41 ejecting the ink, the ink flow path 81 including the first flow path 81b and the second flow path 81c and connecting the ink cartridge 61 and the ink head 41 to each other, the liquid feeding pump 83 provided in the first flow path 81b and feeding the ink in a direction from the ink cartridge 61 toward the ink head 41, and the depressurizing pump 84 provided in the second flow path 81c and feeding the ink in a direction from the ink head 41 toward the ink cartridge 61.

With the printer 10 according to this example embodiment, the liquid feeding pump 83 may be driven to pressurize the inside of the ink flow path 81, and the depressurizing pump 84 may be driven to depressurize the inside of the ink flow path 81. The liquid feeding pump 83 and the depressurizing pump 84 are different pumps from each other, and therefore, the time lag between the pressurization and the depressurization may be reduced or prevented.

With a configuration in which the liquid feeding pump and the depressurizing pump are integrated into one pump and the pump is rotated forward to feed the ink and is rotated reversely to depressurize the ink, the number of the components may be decreased but a time lag occurs when the rotation direction of the pump is switched from the forward direction to the reverse direction. During the time lag, the pump is stopped. When the ink is pressurized and discharged, the ink is accumulated on surfaces of the nozzles, and the ink accumulated on the nozzles close to each other is assembled. When the liquid feeding pump is stopped after the pressurization cleaning, the ink, which is assembled and color-mixed, is pulled into a nozzle having a smaller inner pressure by a difference in the pressure between the nozzles while the pump is stopped by the time lag. This causes the ink to be color-mixed for a long time period or at an unexpected timing during the printing. When the pump is stopped after the pressurization cleaning, in a state where the cap is attached to the ink head, the colors are further mixed.

With the printer 10 according to this example embodiment, the time lag between the pressurization and the depressurization in the pressurization cleaning may be reduced or prevented. In the case where the inside of the ink flow path 81 is depressurized immediately after the pressurization of the inside of the ink flow path 81 is finished, there is no time for the ink, accumulated on the nozzles 42 close to each other, to be color-mixed. Therefore, the risk of the ink of mixed colors being pulled into the nozzles 42 is decreased.

In this example embodiment, the controller 100 is configured or programmed to include the first pressurization controller 121 to close the depressurizing pump 84 and to drive the liquid feeding pump 83 to pressurize the inside of the ink flow path 81 to a pressure at which the ink leaks out from the ink head 41, and the first depressurization controller 122 to close the liquid feeding pump 83 and to drive the depressurizing pump 84 to depressurize the inside of the ink flow path 81. With such a configuration, the inside of the ink flow path 81 is pressurized to cause the ink to leak out from the ink head 41 and thus to clean the nozzles 42, and then the depressurizing pump 84 is driven. In this manner, the pressure inside the ink flow path 81 may be returned to a negative pressure.

The printer 10 according to this example embodiment includes the damper 85, which is capable of storing ink and is in communication with the ink head 41. The ink flow path 81 includes the first branching portion 81e connected with the upstream end of the first flow path 81b and the upstream end of the second flow path 81c and in communication with the ink cartridge 61, the downstream-side common flow path 81d having the downstream end thereof connected with the damper 85, and the second branching portion 81f connected with the downstream end of the first flow path 81b, the downstream end of the second flow path 81c and the upstream end of the downstream-side common flow path 81d. The controller 100 is configured or programmed to include the second depressurization controller 132 to close the liquid feeding pump 83 and to drive the depressurizing pump 84 to depressurize the inside of the ink flow path 81a to a pressure at which the ink is not pulled into the ink head 41, and the second pressurization controller 131 to close the depressurizing pump 84 and to drive the liquid feeding pump 83 to pressurize the inside of the ink flow path 81a to a pressure at which the ink does not leak out from the ink head 41. With such a configuration, the in-and-out stirring, by which the ink is supplied to the damper 85 and is discharged from the damper 85, may be performed. The in-and-out stirring allows the ink in the ink flow path 81, particularly, in the damper 85 to stir, and thus may reduce or prevent the sedimentation of the components of the ink.

### Example Embodiment 2

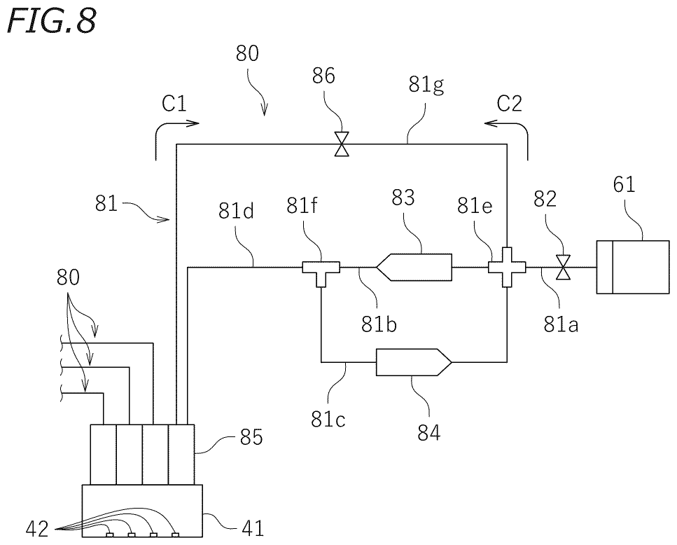

In example embodiment 2, the ink flow path 81 further includes a flow path through which the ink is circulated. FIG. 8 is a schematic view showing a configuration of the ink supply system 80 according to example embodiment 2. As shown in FIG. 8, the ink flow path 81 according to this example embodiment includes a third flow path 81g having one of two ends thereof connected with the first branching portion 81e and having the other end thereof connected with the damper 85. The printer 10 includes a second valve 86 provided in the third flow path 81g. Hereinafter, the valve 82 provided in the upstream-side common flow path 81 will be referred to also as the “first valve 82” in order to be distinguished from the second valve 86. As shown in FIG. 8, the first branching portion 81e may be formed of a joint branched into four directions, and may include two branching components. There is no specific limitation on the configuration of the branching portion as long as the flow paths are connected with each other in the same manner.

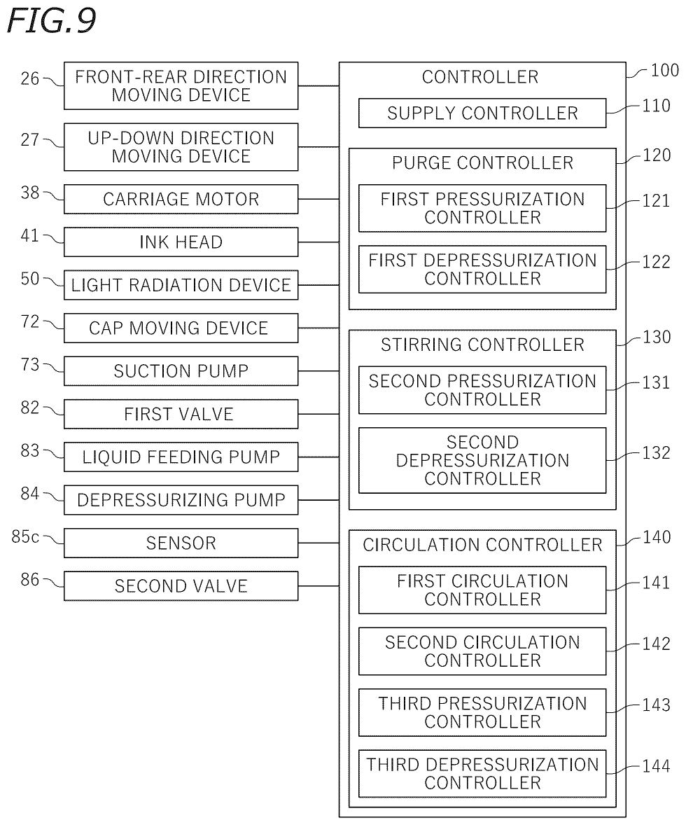

FIG. 9 is a block diagram of the printer 10 according to example embodiment 2. As shown in FIG. 9, the printer 10 according to example embodiment 2 includes a circulation controller 140 in addition to the components included in the printer 10 according to example embodiment 1. The circulation controller 140 is configured or programmed to include a first circulation controller 141, a second circulation controller 142, a third pressurization controller 143, and a third depressurization controller 144.

The first circulation controller 141 is configured or programmed to close the first valve 82 and the depressurizing pump 84, to open the second valve 86, and to drive the liquid feeding pump 83. In this manner, the first circulation controller 141 is configured or programmed to circulate the ink in the direction of an arrow C1 in FIG. 8. Hereinafter, this circulation direction of the ink will be referred to also as the “forward circulation direction”. The second circulation controller 142 is configured or programmed to close the first valve 82 and the liquid feeding pump 83, to open the second valve 86, and to drive the depressurizing pump 84. In this manner, the second circulation controller 142 is configured or programmed to circulate the ink in the direction of an arrow C2 in FIG. 8. Hereinafter, this circulation direction of the ink will be referred to also as the “reverse circulation direction”. The circulation controller 140 is capable of circulating the ink both in the forward circulation direction and the reverse circulation direction. Hereinafter, a circulation performed in the forward circulation direction and the reverse circulation direction alternately will be referred to also as a “bidirectional circulation”.

The third pressurization controller 143 is configured or programmed to open the first valve 82, to close the second valve 86 and the depressurizing pump 84, and to drive the liquid feeding pump 83 to pressurize the inside of the damper 85. In this example embodiment, the printer 10 is capable of performing the forward direction circulation, the reverse direction circulation or the bidirectional circulation in a state where the inside of the damper 85 is pressurized as being controlled by the third pressurization controller 143. The first circulation controller 141 and the second circulation controller 142 are configured or programmed to act together as a third circulation controller configured or programmed to close the first valve 82 and to open the second valve 86 in the state where the inside of the damper 85 is pressurized as being controlled by the third pressurization controller 143 and to further drive one of the liquid feeding pump 83 and the depressurizing pump 84 and to close the other of the liquid feeding pump 83 and the depressurizing pump 84.

The third depressurization controller 144 is configured or programmed to open the first valve 82, to close the second valve 86 and the liquid feeding pump 83, and to drive the depressurizing pump 84 to depressurize the inside of the damper 85. In this example embodiment, the printer 10 is capable of performing the forward direction circulation, the reverse direction circulation and the bidirectional circulation in a state where the inside of the damper 85 is depressurized as being controlled by the third depressurization controller 144. The first circulation controller 141 and the second circulation controller 142 are configured or programmed to act together as a fourth circulation controller configured or programmed to close the first valve 82 and to open the second valve 86 in the state where the inside of the damper 85 is depressurized as being controlled by the third depressurization controller 144 and further to drive one of the liquid feeding pump 83 and the depressurizing pump 84 and closes the other of the liquid feeding pump 83 and the depressurizing pump 84.

Hereinafter, the circulation of the ink performed in the state where the inside of the damper 85 is pressurized will be referred to as “pressurization circulation”, and the circulation of the ink performed in the state where the inside of the damper 85 is depressurized will be referred to as “depressurization circulation”. The pressurization circulation and the depressurization circulation will collectively be referred to as “pressure adjustment circulation”. A combination of the pressurization/depressurization and the circulation direction of the ink will be expressed as, for example, pressurization-forward direction circulation, depressurization-bidirectional circulation or the like.

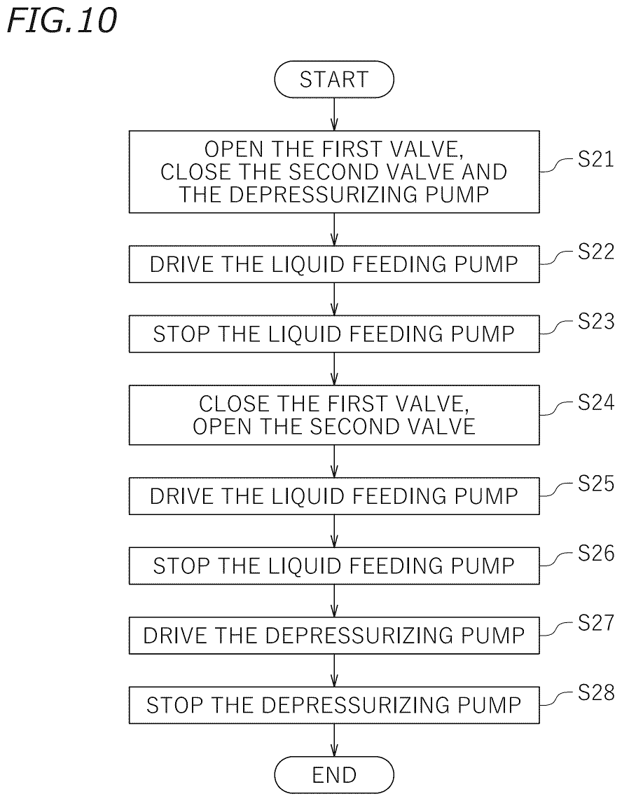

FIG. 10 is a flowchart showing an example of the pressure adjustment circulation. Hereinafter, with reference to FIG. 10, a process of the pressurization-bidirectional circulation as an example of the pressure adjustment circulation will be described.

As shown in FIG. 10, in step S21 of the pressurization-bidirectional circulation, the first valve 82 is opened, and the second valve 86 and the depressurizing pump 84 are closed. In step S22, the liquid feeding pump 83 is driven to pressurize the inside of the damper 85. Since the first valve 82 is opened, when the liquid feeding pump 83 is driven, the ink is moved into the damper 85 from the ink cartridge 61. Since the second valve 86 and the depressurizing pump 84 are closed, the ink moves toward the damper 85 without circulating. As a result, the inside of the damper 85 is pressurized. The damper 85 is expanded by being pressurized. In step S22, the inside of the ink flow path 81 is pressurized to a pressure at which the ink does not leak out from the ink head 41. For the case where the ink leaks out from the ink head 41, the ink head 41 may have the cap 71 attached thereto. In this case also, the pressure inside the ink flow path 81 is managed by the amount of the ink fed to the ink head 41 by the liquid feeding pump 83. When the rotation angle of the liquid feeding pump 83 reaches a predetermined rotation angle, the liquid feeding pump 83 is stopped in step S23. Note that the liquid feeding pump 83 is driven again later in step S25, and therefore, does not need to be stopped in the case where it brings no problem even if the liquid feeding pump 83 is not stopped.

In step S24, the first valve 82 is closed and the second valve 86 is opened. As a result, the damper 85 and the ink cartridge 61 are blocked from each other, and the third flow path 81g for ink circulation is opened. In step S25, the liquid feeding pump 73 is driven. At this point, the depressurizing pump 84 is closed. As a result of step S25, the ink is circulated in the direction of the arrow C1 in FIG. 8 in a pressurized state.

When a predetermined time period elapses after the start of step S25, the liquid feeding pump 83 is stopped (closed) in step S26. In step S27, the depressurizing pump 84 is driven. As a result of step S27, the ink is circulated in the direction of the arrow C2 in FIG. 8 in a pressurized state. When a predetermined time period elapses after the start of step S27, the depressurizing pump 84 is stopped (closed) in step S28. In steps S25 through S28, one cycle of the pressurization-bidirectional circulation is performed. After this, the operation of steps S25 and S26 and the operation of steps S27 and S28 may be repeated alternately, although not shown. As shown in FIG. 10, the operation of steps S25 and S26 and the operation of steps S27 and S28 may be performed alternately once. In the bidirectional circulation, the circulation in the direction of the arrow C2 may be performed before the circulation in the direction of the arrow C1. When the repetition of the operation of steps S25 and S26 and the operation of steps S27 and S28 is finished, the pressurization-bidirectional circulation is finished. Note that after this, a step of depressurizing the inside of the ink flow path 81 may be performed.

For performing the depressurization circulation, in a step corresponding to step S21, the first valve 82 may be opened and the second valve 86 and the liquid feeding pump 83 may be closed. Further in a step corresponding to step S22, the depressurizing pump 84 may be driven to depressurize the inside of the damper 85. For performing the forward direction circulation, steps S27 and S28 may be omitted. For performing the reverse direction circulation, steps S25 and S26 may be omitted.

In this example embodiment also, the pressurization cleaning and the in-and-out stirring may be performed in substantially the same manner as in example embodiment 1. In this example embodiment, during the pressurization cleaning and the in-and-out stirring, the second valve 86 is closed. The forward direction circulation, the reverse direction circulation or the bidirectional circulation may be performed with no pressurization or depressurization. In such a case, steps S21 through S23 are omitted. In this example embodiment, any of various types of ink stirring including the in-and-out stirring, the pressurization/depressurization circulation, and the forward direction/reverse direction/bidirectional circulation may be performed.

Hereinafter, the functions and effects provided by the printer 10 according to example embodiment 2 will be described.

In this example embodiment, the ink flow path 81 includes the upstream-side common flow path 81a having the upstream end thereof connected with the ink cartridge 61 and having the downstream end thereof connected with the first branching portion 81e, and the third flow path 81g having an upstream end thereof connected with the first branching portion 81e and having a downstream end thereof connected with the damper 85. The printer 10 includes the first valve 82 provided in the upstream-side common flow path 81a, and the second valve 86 provided in the third flow path 81g. With such a configuration, the ink may be flowed into the third flow path 81g and circulated. The circulation of the ink also allows the ink to be stirred and may reduce or prevent the sedimentation of the components of the ink.

In this example embodiment, the controller 100 is configured or programmed to include the first circulation controller 141 configured or programmed to close the first valve 82 and the depressurizing pump 84, to open the second valve 86 and to drive the liquid feeding pump 83, and the second circulation controller 142 configured or programmed to close the first valve 82 and the liquid feeding pump 83, to open the second valve 86 and to drive the depressurizing pump 84. With such a configuration, the bidirectional circulation of changing the circulation direction of the ink in the middle may be performed. The bidirectional circulation, by the turbulence generated at the time when the circulation direction is changed, allows the ink to be stirred efficiently in an area where the ink is not easily stirred, for example, in the vicinity of walls of the ink flow path 81 or the damper 85, where the ink flows slowly.

In this example embodiment, the controller 100 is configured or programmed to include the third pressurization controller 143 configured or programmed to open the first valve 82, to close the second valve 86 and the depressurizing pump 84 and to drive the liquid feeding pump 83 to pressurize the inside of the damper 85. The controller 100 is configured or programmed to close the first valve 82 and to open the second valve 86 in the state where the inside of the damper 85 is pressurized as being controlled by the third pressurization controller 143, and further to drive one of the liquid feeding pump 83 and the pressurizing pump 84 and to close the other of the liquid feeding pump 83 and the pressurizing pump 84. With such a configuration, the ink may be circulated in the state where the inside of the damper 85 is pressurized. In the pressurized state, the damper 85 accommodates a large amount of the ink. Therefore, the ink may be stirred efficiently in an area where the ink is not easily stirred, for example, in the vicinity of a corner of an inner space of the damper 85.

In this example embodiment, the controller 100 is configured or programmed to include the third depressurization controller 144 configured or programmed to open the first valve 82, to close the second valve 86 and the liquid feeding pump 83 and to drive the depressurizing pump 84 to depressurize the inside of the damper 85. The controller 100 is configured or programmed to close the first valve 82 and open the second valve 86 in the state where the inside of the damper 85 is depressurized as being controlled by the third depressurization controller 144, and further to drive one of the liquid feeding pump 83 and the depressurizing pump 84 and to close the other of the liquid feeding pump 83 and the depressurizing pump 84. With such a configuration, the ink may be circulated in the state where the inside of the damper 85 is depressurized. In the depressurized state, the damper 85 accommodates only a small amount of the ink. Therefore, the entirety of the ink is easily stirred.

### Example Embodiment 3

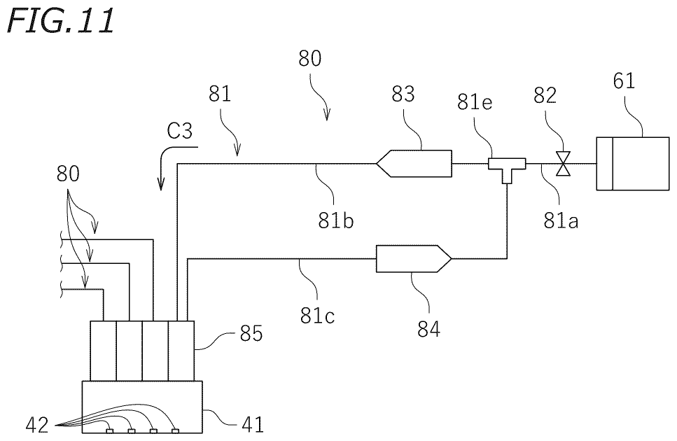

In example embodiment 3, the first flow path 81b and the second flow path 81c are used also as a circulation path. FIG. 11 is a schematic view showing a configuration of the ink supply system 80 according to example embodiment 3. As shown in FIG. 11, in this example embodiment, the downstream end of the first flow path 81b and the downstream end of the second flow path 81c are connected with the damper 85.

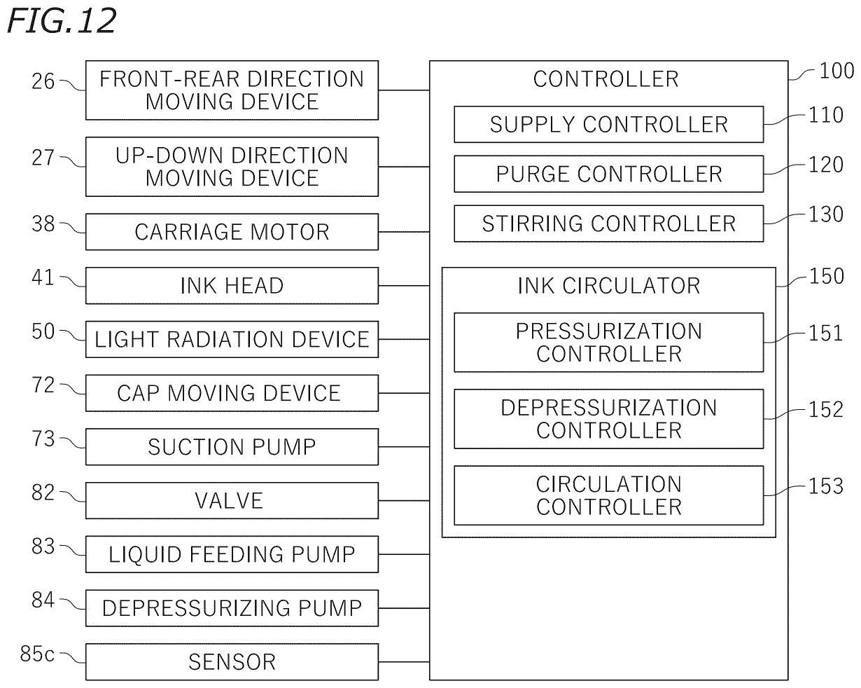

FIG. 12 is a block diagram of the printer 10 according to example embodiment 3. As shown in FIG. 12, the controller 100 according to example embodiment 3 is configured or programmed to include the supply controller 110, the purge controller 120 and the stirring controller 130 each having substantially the same configuration as that of the controller 100 according to example embodiment 1. The controller 100 according to example embodiment 3 is configured or programmed to include an ink circulator 150 performing circulation control different from that performed by the controller 100 according to example embodiment 2.

The ink circulator 150 is configured or programmed to control operations of components: involved in the pressure adjustment circulation. As shown in FIG. 12, the ink circulator 150 is configured or programmed to include a pressurization controller 151, a depressurization controller 152, and a circulation controller 153. The pressurization controller 151 is configured or programmed to open the valve 82, to close the depressurizing pump 84, and to drive the liquid feeding pump 83 to pressurize the inside of the damper 85. The depressurization controller 152 is configured or programmed to open the valve 82, to close the liquid feeding pump 83, and to drive the depressurizing pump 84 to depressurize the inside of the damper 85. The circulation controller 153 is configured or programmed to close the valve 82 in a state where the inside of the damper 85 is pressurized as being controlled by the pressurization controller 151 or in a state where the inside of the damper 85 is depressurized as being controlled by the depressurization controller 152. The circulation controller 153 is configured or programmed to further drive the liquid feeding pump 83 and the depressurizing pump 84, or to drive one of the liquid feeding pump 83 and the depressurizing pump 84 and to open the other of the liquid feeding pump 83 and the depressurizing pump 84. With such control, the circulation controller 153 is configured programmed to circulate the ink in the ink flow path 81 in the direction of an arrow C3 in FIG. 11.

In this example embodiment, the circulation controller 153 is configured or programmed to drive the liquid feeding pump 83 and to open the depressurizing pump 84 in the state where the inside of the damper 85 is pressurized as being controlled by the pressurization controller 151 or in the state where the inside of the damper 85 is depressurized as being controlled by the depressurization controller 152. Note that the circulation controller 153 may open the liquid feeding pump 83 and drive the depressurizing pump 84 in the state where the inside of the damper 85 is pressurized as being controlled by the pressurization controller 151 or in the state where the inside of the damper 85 is depressurized as being controlled by the depressurization controller 152. Alternatively, the circulation controller 153 may be configured or programmed to drive both of the liquid feeding pump 83 and the depressurizing pump 84 in the state where the inside of the damper 85 is pressurized as being controlled by the pressurization controller 151 or in the state where the inside of the damper 85 is depressurized as being controlled by the depressurization controller 152.

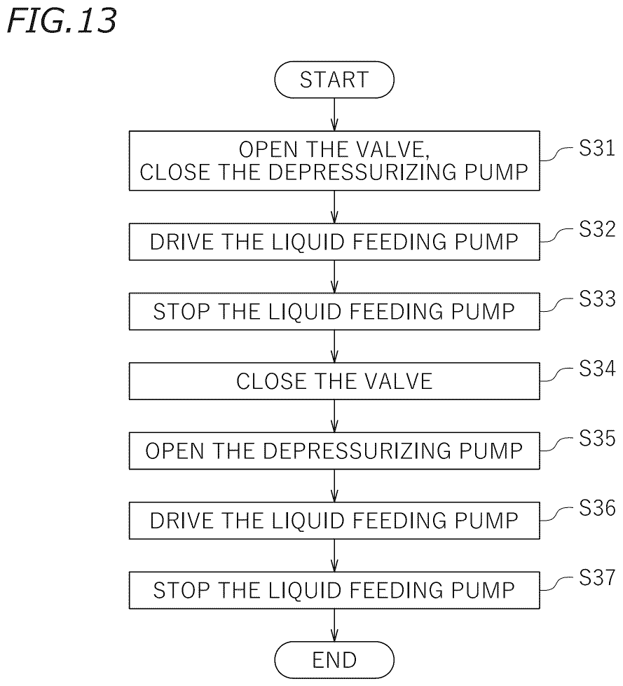

FIG. 13 is a flowchart showing an example of the pressure adjustment circulation performed by the printer 10 according to example embodiment 3. Hereinafter, with reference to FIG. 13, a process of the pressurization circulation as an example of the pressure adjustment circulation will be described.

As shown in FIG. 13, in step S31 of the pressure adjustment circulation performed by the printer 10 according to this example embodiment, the valve 82 is opened and the depressurizing pump 84 is closed. In step S32, the liquid feeding pump 83 is driven to pressurize the inside of the damper 85. Since the depressurizing pump 84 is closed, the ink does not escape from the damper 85 into the second flow path 85c. Therefore, the inside of the damper 85 is pressurized. In step S33, the liquid feeding pump 83 is stopped. Note that the liquid feeding pump 83 is driven again later in step S35, and therefore, does not need to be stopped in the case where it brings no problem even if the liquid feeding pump 83 is not stopped.

In step S34, the valve 82 is closed. In step S35, the depressurizing pump 84 is opened. In step S36, the liquid feeding pump 83 is driven. As a result, the ink is circulated in the direction of the arrow C3 in FIG. 11 in a pressurized state. When a predetermined time period elapses after the start of step S36, the liquid feeding pump 83 is stopped (closed) in step S37. When step S37 is finished, the pressurization circulation is finished. Note that after this, a step of depressurizing the inside of the ink flow path 81 may be performed.

For performing the depressurization circulation, in a step corresponding to step S31, the valve 82 may be opened and the liquid feeding pump 83 may be closed. Further in a step corresponding to step S32, the depressurizing pump 84 may be driven to depressurize the inside of the damper 85. The ink circulation may be performed with no pressurization or depressurization. In such a case, steps S31 through S33 are omitted.

Hereinafter, the functions and effects provided by the printer 10 according to example embodiment 3 will be described.

In this example embodiment, the downstream end of the first flow path 81b and the downstream end of the second flow path 81c are connected with the damper 85. With such a configuration, the inner space of the damper 85 may be used to form a circulation flow path including the damper 85 even without a flow path for circulation such as the third flow path 81g being provided.

In this example embodiment, the controller 100 is configured or programmed to include the pressurization controller 151 configured or programmed to open the valve 82, to close the depressurizing pump 84 and to drive the liquid feeding pump 83 to pressurize the inside of the damper 85, and the circulation controller 153 is configured or programmed to close the valve 82 in the state where the inside of the damper 85 is pressurized as being controlled by the pressurization controller 151 and further to drive the liquid feeding pump 83 and the depressurizing pump 84 or to drive one of the liquid feeding pump 83 and the depressurizing pump 84 and to open the other of the liquid feeding pump 83 and the depressurizing pump 84. With such a configuration, the pressurization circulation substantially the same as that in example embodiment 2 may be performed with a simple configuration.

In this preferred example embodiment, the controller 100 is configured or programmed to include the depressurization controller 152 configured or programmed to open the valve 82, to close the liquid feeding pump 83 and to drive the depressurizing pump 84 to depressurize the inside of the damper 85. The circulation controller 153 is configured or programmed to close the valve 82 in the state where the inside of the damper 85 is depressurized as being controlled by the depressurization controller 152, and further to drive the liquid feeding pump 83 and the depressurizing pump 84, or to drive one of the liquid feeding pump 83 and the depressurizing pump 84 and to open the other of the liquid feeding pump 83 and the depressurizing pump 84. With such a configuration, the depressurization circulation substantially the same as that in example embodiment 2 may be performed with a simple configuration.

Some example embodiments are described above. The printers according to example embodiments of the present invention are not limited to any of the above-described example embodiments. For example, the configuration of the ink supply system 80 is not limited to any of the above. The ink supply system 80 may further include another tube, another valve or the like. Alternatively, for example, the valve 82 may be omitted in example embodiment 1.

The processes of the pressurization cleaning, the in-and-out stirring, the pressurization/depressurization circulation, and the forward direction/reverse direction/bidirectional circulation in the above-described example embodiments are merely examples. The pressurization cleaning, the in-and-out stirring, the pressurization/depressurization circulation, or the forward direction/reverse direction/bidirectional circulation may be performed by any other process.

In the above-described example embodiments, the printer 10 is a flat bed-type printer. However, there is no specific limitation on the configuration of the printer. The technology disclosed herein may be applied to, for example, a printer of a type in which the recording medium is a supplied from a roll. The configuration of the printer 10 described above is merely an example in any other point, and the printers according to example embodiments of the present invention are not limited to any specific type.

The above-described example embodiments do not limit the present invention unless otherwise specified.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms or example embodiments. This disclosure should be regarded as providing example embodiments of the principles of the present invention. These example embodiments are provided with the understanding that they are not intended to limit the present invention to the example embodiments described in the specification and/or shown in the drawings. The present invention is not limited to the example embodiments described herein. The present invention encompasses any of example embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the example embodiments described in this specification or used during the prosecution of the present application.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printer, comprising:
an ink container to accommodate ink;
an ink head to eject the ink;
an ink flow path including a first flow path and a second flow path, the ink flow path connecting the ink container and the ink head to each other;
a liquid feeding pump provided in the first flow path to feed the ink in a direction from the ink container toward the ink head; and
a depressurizing pump provided in the second flow path to feed the ink in a direction from the ink head toward the ink container.

2. The printer according to claim 1, further comprising a controller configured or programmed to control the liquid feeding pump and the depressurizing pump, wherein the controller is configured or programmed to include:
a first pressurization controller configured or programmed to close the depressurizing pump and to drive the liquid feeding pump to pressurize an inside of the ink flow path to a pressure at which the ink leaks out from the ink head; and
a first depressurization controller configured or programmed to close the liquid feeding pump and to drive the depressurizing pump to depressurize the inside of the ink flow path.

3. The printer according to claim 1, further comprising an intermediate container capable of storing the ink, the intermediate container being in communication with the ink head; wherein:
the ink flow path includes:
a first branching portion connected with one of two ends of the first flow path and one of two ends of the second flow path, and in communication with the ink container;
a first common flow path having one of two ends thereof connected with the intermediate container; and
a second branching portion connected with the other end of the first flow path, the other end of the second flow path and the other end of the first common flow path.

4. The printer according to claim 3, further comprising a controller configured or programmed to control the liquid feeding pump and the depressurizing pump, wherein the controller is configured or programmed to include:
a second depressurization controller configured or programmed to close the liquid feeding pump and to drive the depressurizing pump to depressurize an inside of the ink flow path to a pressure at which the ink is not pulled into the ink head; and
a second pressurization controller configured or programmed to close the depressurizing pump and to drive the liquid feeding pump to pressurize the inside of the ink flow path to a pressure at which the ink does not leak out from the ink head.

5. The printer according to claim 3, wherein
the ink flow path further includes:
a second d common flow path having one of two ends thereof connected with the ink container and having the other end thereof connected with the first branching portion; and
a third flow path having one of two ends thereof connected with the first branching portion and having the other end thereof connected with the intermediate container; and
the printer further includes:
a first valve in the second common flow path; and
a second valve in the third flow path.

6. The printer according to claim 5, further comprising a controller configured or programmed to control the liquid feeding pump, the depressurizing pump, the first valve and the second valve, the controller is configured or programmed to include:
a first circulation controller configured or programmed to close the first valve and the depressurizing pump, to open the second valve, and to drive the liquid feeding pump; and
a second circulation controller configured or programmed to close the first valve and the liquid feeding pump, to open the second valve, and to drive the depressurizing pump.

7. The printer according to claim 5, further comprising a controller configured or programmed to control the liquid feeding pump, the depressurizing pump, the first valve and the second valve, the controller is configured or programmed to include
a third pressurization controller configured or programmed to open the first valve, to close the second valve and the depressurizing pump, and to drive the liquid feeding pump to pressurize an inside of the intermediate container; and
a third circulation controller configured or programmed to close the first valve and to open the second valve in a state where the inside of the intermediate container is pressurized as being controlled by the third pressurization controller, and to further drive one of the liquid feeding pump and the depressurizing pump and to close the other of the liquid feeding pump and the depressurizing pump.

8. The printer according to claim 5, further comprising a controller configured or programmed to control the liquid feeding pump, the depressurizing pump, the first valve and the second valve, wherein the controller is configured or programmed to include:
a third depressurization controller configured or programmed to open the first valve, to close the second valve and the liquid feeding pump, and to drive the depressurizing pump to depressurize an inside of the intermediate container; and
a fourth circulation controller configured or programmed to close the first valve and to open the second valve in a state where the inside of the intermediate container is depressurized as being controlled by the third depressurization controller, and to further drive one of the liquid feeding pump and the depressurizing pump and to close the other of the liquid feeding pump and the depressurizing pump.

9. The printer according to claim 1, further comprising an intermediate container capable of storing the ink, the intermediate container being in communication with the ink head; wherein
the ink flow path includes a branching portion connected with one of two ends of the first flow path and one of two ends of the second flow path, and in communication with the ink container; and
the other end of the first flow path and the other end of the second flow path are connected with the intermediate container.

10. The printer according to claim 9, further comprising a controller configured or programmed to control the liquid feeding pump and the depressurizing pump, wherein the controller is configured or programmed to include:
a fourth depressurization controller configured or programmed to close the liquid feeding pump and to drive the depressurizing pump to depressurize an inside of the ink flow path to a pressure at which the ink is not pulled into the ink head; and
a fourth pressurization controller configured or programmed to close the depressurizing pump and to drive the liquid feeding pump to pressurize the inside of the ink flow path to a pressure at which the ink does not leak out from the ink head.

11. The printer according to claim 9, wherein:
the ink flow path includes a common flow path having one of two ends thereof connected with the ink container and having the other end thereof connected with the branching portion; the printer further includes:
a valve provided in the common flow path; and
a controller configured or programmed to control the liquid feeding pump, the depressurizing pump and the valve; and
the controller is configured or programmed to include:
a fifth pressurization controller configured or programmed to open the valve, to close the depressurizing pump, and to drive the liquid feeding pump to pressurize an inside of the intermediate container; and
a fifth circulation controller configured or programmed to close the valve in a state where the inside of the intermediate container is pressurized as being controlled by the fifth pressurization controller, and further to drive the liquid feeding pump and the depressurizing pump, or to drive one of the liquid feeding pump and the depressurizing pump and to open the other of the liquid feeding pump and the depressurizing pump.

12. The printer according to claim 9, wherein
the ink flow path includes a common flow path having one of two ends thereof connected with the ink container and having the other end thereof connected with the branching portion; the printer further includes:
a valve in the common flow path; and
a controller configured or programmed to control the liquid feeding pump, the depressurizing pump and the valve; and
the controller is configured or programmed to include:
a fifth depressurization controller configured or programmed to open the valve, to close the liquid feeding pump, and to drive the depressurizing pump to depressurize an inside of the intermediate container; and
a sixth circulation controller configured or programmed to close the valve in a state where the inside of the intermediate container is depressurized as being controlled by the fifth depressurization controller, and to further drive the liquid feeding pump and the depressurizing pump, or to drive one of the liquid feeding pump and the depressurizing pump and to open the other of the liquid feeding pump and the depressurizing pump.
